(19) United States
(12) Patent Application Publication
(10) Pub. No.: US 2021/0056167 A1
(43) Pub. Date: Feb. 25, 2021

(54) CHATBOT WITH USER ASSOCIATED LANGUAGE IMPERFECTIONS

(71) Applicant: International Business Machines Corporation, Armonk, NY (US)

(72) Inventors: Joseph Lam, Markham (CA); Hau Co, Sharon (CA); Jeremy R. Fox, Georgetown, TX (US); Trudy L. Hewitt, Cary, NC (US)

(21) Appl. No.: 16/545,329

(22) Filed: Aug. 20, 2019

(51) Int. Cl. G06F 17/27; G06Q 50/00

(52) U.S. Cl. CPC G06F 17/274; G06Q 50/01; G06F 17/2785

(57) ABSTRACT

Aspects of this disclosure relate to humanizing a chatbot. A message that includes a prompt is received from a user. Data of the user is gathered. Using the data, a language imperfection associated with the user is identified. A reply to the prompt that includes the language imperfection is generated.

### BACKGROUND

A chatbot may be a computer and/or a computer program that is designed to hold a conversation or otherwise answer questions or respond to prompts of a person. A chatbot may receive and answer questions over a computing interface via text or voice/audio or the like. Chatbots may be configured to utilize dictionaries and grammatical rulebooks or the like to have near perfect language usage.

### SUMMARY

Aspects of the present disclosure relate to a method, system, and computer program product relating to making a chatbot appear human. For example, the method may include receiving, from a user, a message that includes a prompt. The method may also include gathering data of the user. The method may further include identifying, using the data, a language imperfection associated with the user. The method may further include generating a reply to the prompt that includes the language imperfection. A system and computer product configured to perform the above method are also disclosed.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a conceptual diagram of an example system in which a controller introduces user associated language imperfections into a chatbot.

FIG. 2 depicts a conceptual box diagram of a computing system that may be configured to introduce user associated language imperfections into a chatbot.

FIG. 3 depicts an example flowchart of making a chatbot appear more human.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to making a chatbot appear more human, while more particular aspects of the present disclosure relate to identifying language imperfections of a user and responding to communication from that user using those language imperfections. While the present disclosure is not necessarily limited to such applications, various aspects of the disclosure may be appreciated through a discussion of various examples using this context.

A chatbot may include a computer and/or a software program used by a computer to communicate with a person. The chatbot may communicate over a computing interface via verbal/auditory input (e.g., such that the user speaks into a microphone and the chatbot communicates back to the person over a speaker) and/or via text input (e.g., such that a user types into a user interface (UI) window and the chatbot responds with a message generated into that UI window). Conventional chatbots may be configured to respond with near-perfect precision and accuracy, responding to queries nearly instantly with no typographical errors, grammatical errors, mathematical errors, or other types of errors.

In certain examples, organizations may want chatbots to pass for (e.g., impersonate) humans. Organizations may want chatbots to pass for humans in order to entertain or amuse the people that are interacting with the chatbot. Additionally, or alternatively, chatbots that can effectively impersonate humans may receive better feedback from users, as the users may have more patience dealing with what the user thinks is a human than with a chatbot. As such, organizations may customize chatbots to try to make those chatbots appear relatively more human. For example, organizations may provide audible chatbots with human sounding voices that use various tones as are appropriate for the given chatbot response (e.g., rather than being monotone), and/or organizations may configure chatbots to provide jokes or otherwise utilize informal language. However, users may still be able to detect that they are communicating with a chatbot for many reasons, such as a consistent language accuracy and precision as utilized by the chatbot.

Aspects of the disclosure relate to incorporating language imperfections into responses to the user to improve the ability of the chatbot to appear human. A computing agent, hereinafter referred to as a controller, may control incorporating the language imperfections into the chatbot. The controller may gather data on the user to identify language imperfections that are associated with the user. For example, the controller may identify language imperfections that the user has previously made. The controller may then generate a response to a prompt of the user that includes the language imperfection. By utilizing language imperfections previously utilized or otherwise associated with the user, the user may have a positive reaction to the usage of these imperfections.

The controller may compile a profile of the user to determine language preferences of the user. The profile may include factors that indicate whether or not the user may have a positive or negative reaction to the usage of the language imperfections. The profile may include previous usages of the language imperfections both by and to the user. The profile may further include demographic factors such as a job of the user or hobbies of the user. The profile may further include determined user preferences such as a preferred severity of the language imperfection (e.g., where the severity may include the frequency with which the language imperfection occurs, and/or how dramatic it is, such as how many letters are incorrect in a typographical error). In some examples, prior to generating a response to the user that incorporates the language imperfection, the controller may verify that the language imperfection matches the profile.

For example, the controller may determine that a user misspelled a pharmaceutical over a communication, identifying this as a language imperfection. The controller may further receive a prompt from the user to a chatbot via a user interface (UI), subsequently determining that a response to the prompt includes a pharmaceutical, such that a chatbot reply could include the language imperfection. The controller may therein consult the profile and identify that the user is a doctor, such that the user may have a relatively negative reaction to a misspelled pharmaceutical in comparison to a user who worked a different profession (even though that user has previously misspelled a pharmaceutical). Similarly, the controller may determine that an engineer may react negatively to calculation errors, and a journalist may react negatively to grammatical errors, or the like, even if such users have made or have otherwise been associated with similar imperfections previously. In this way aspects of the disclosure may be configured to make a chatbot appear more human in a manner that a user may find most pleasant and confidence-inducing.

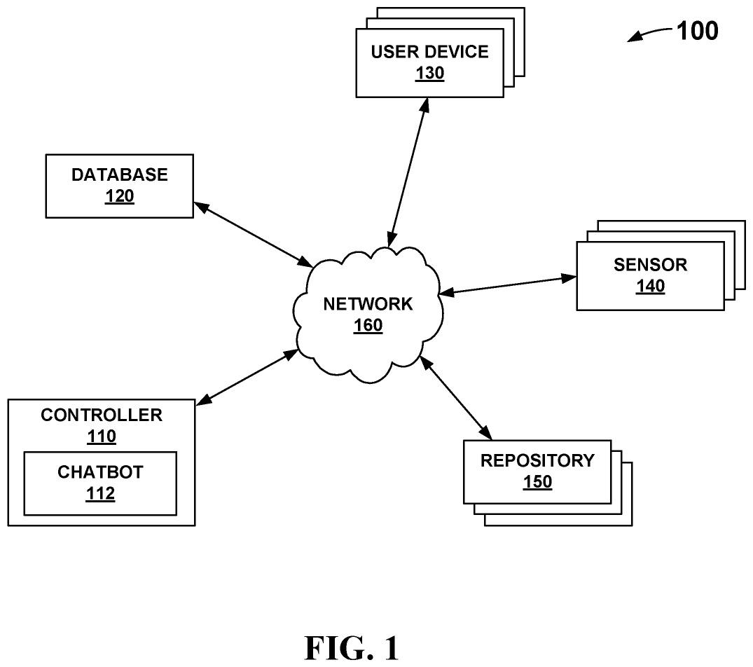

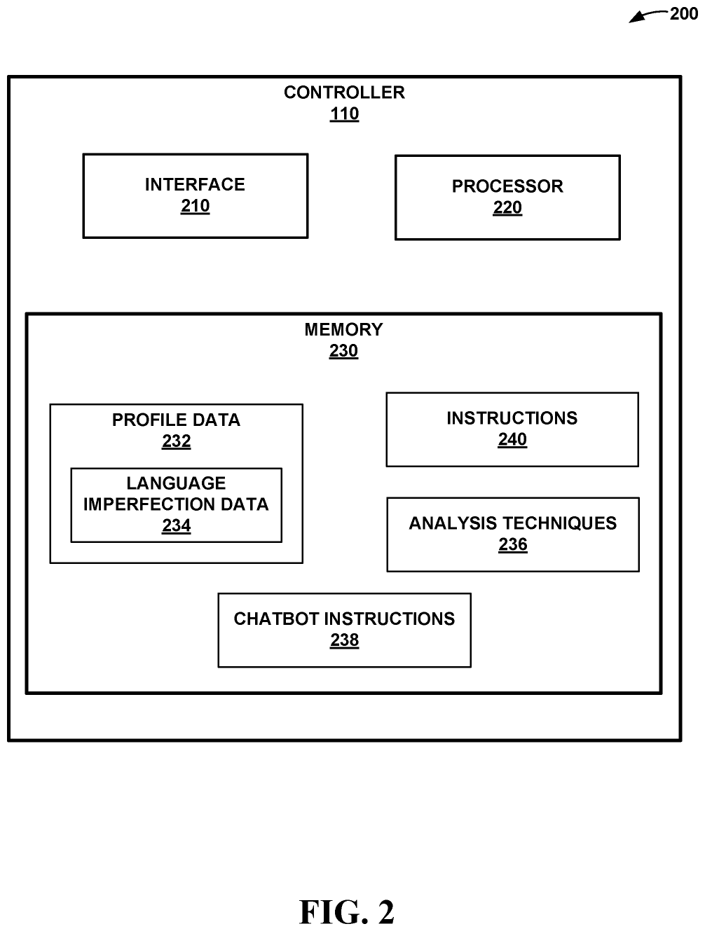

For example, FIG. 1 depicts system 100 that includes controller 110 that is configured to make a chatbot appear more human. Controller 110 may include a computing device, such as computing device 200 of FIG. 2 that includes a processor communicatively coupled to a memory that includes instructions that, when executed by the processor, cause controller 110 to execute the operations described below. As depicted in FIG. 1 controller 110 may include chatbot 112. Chatbot 112 may include a software program (e.g., such as chatbot instructions 238 of FIG. 2) configured to communicate audibly or textually or the like with a user via a virtual interface. Though FIG. 1 depicts controller 110 as including chatbot 112 for purposes of illustration, in other examples chatbot 112 may include or be stored in a separate computing device that is communicatively coupled to controller 110.

A user may communicate with chatbot 112 via a virtual interface accessed by one or more user devices 130. User devices 130 may include computing devices (e.g., devices similar to computing device 200 of FIG. 2) such as laptops, desktops, mobile phones, tablets, or the like. A user may interact with chatbot 112 to answer questions (e.g., where chatbot 112 functions as a “help desk” for an organization) and/or for enjoyment or curiosity. Chatbot 112 may receive and send messages to user devices 130 over network 160. Network 160 may include a computing network over which computing messages may be sent and/or received. For example, network 160 may include the Internet, a local area network (LAN), a wide area network (WAN), a wireless network such as a wireless LAN (WLAN), or the like. Network 160 may comprise copper transmission cables, optical transmission fibers, wireless transmission, routers, firewalls, switches, gateway computers and/or edge servers. A network adapter card or network interface in each computing/processing device (e.g., controller 110, database 120, user devices 130, sensors 140, and/or repositories 150) may receive messages and/or instructions from and/or through network 160 and forward the messages and/or instructions for storage or execution or the like to a respective memory or processor of the respective computing/processing device.

Though network 160 is depicted as a single entity in FIG. 1 for purposes of illustration, in other examples network 160 may include a plurality of private or public networks. For example, controller 110 may store data related to users and/or communication on database 120, such that controller 110 and database 120 may communicate together over a private LAN of network 160. For another example, controller 110 may gather data from one or more sensors 140 to make chatbot 112 appear more human, where sensors 140 and user device 130 communicate together over a private WLAN of network 160. Additionally, controller 110 may gather data related to users from repositories 150 over a public portion of network 160 using the Internet.

Controller 110 may gather data on users. Controller 110 may gather data on users in response to an affirmative opt-in from users. In some examples, controller 110 may exclusively gather publicly available data on users. Where controller 110 is configured to gather data from relatively private sources (e.g., such as sensors 140 as described herein), controller 110 may further gain an additional more detailed opt-in from users prior to gathering this data that describe the specific devices that controller 110 may gather from and an accounting of what controller 110 will do with that data (e.g., identify language imperfections that the user may have a positive and/or negative reaction to). Controller 110 may store gathered data in database 120. Database 120 may include a computing device (e.g., similar to computing device 200 of FIG. 2) such as a server or rack of servers or the like. Though database 120 is depicted as a separate device from controller 110 for the sake of illustration, in other examples database 120 may be integrated into controller 110 (e.g., similar to the depiction of FIG. 2).

The data gathered by controller 110 may include language imperfections associated with the user. As used herein, language imperfections may include a usage of language that does not align with an objectively “correct” usage as defined by one or more language arbiters such as dictionaries, grammar rule books, mathematical treatises, scientific treatises or the like. For example, language imperfections may include typographical errors (e.g. capitalization errors, spelling errors, incorrect word usage, such as switching “than” with “then”, etc.), grammatical errors (e.g. unnecessary commas, missed periods, etc.), mathematical errors, mispronunciations (e.g., when chatbot 112 interacts with user devices 130 via a verbal virtual interface), or the like.

Controller 110 may gather language imperfections of users that are sent to chatbot 112, such as via previous messages sent by the users to the chatbot. In other examples, controller 110 may gather language imperfections from other repositories 150 online. For example, controller 110 may gather language imperfections from a social media repository 150. Controller 110 may gather language imperfections from repositories 150 both as they are generated by the user and as they are sent to and/or consumed by the user. For example, controller 110 may identify communication that is posted or sent by the user across various social media platforms or communication platforms or the like as language imperfections (e.g., identify communication as language imperfections by affirmatively identifying that the communication as made or consumed by the user does not match the “correct” usage from official language arbiters as described above).

In some examples, controller 110 may identify a language imperfection as associated with the user after the user makes or sends that language imperfection a threshold number of time (e.g., five or ten times). For another example, controller 110 may gather a communication that is sent to the user as language imperfection in response to the user replying to it and/or not correcting it or the like. In such examples, controller 110 may identify these as language imperfections associated with the user after a threshold number of people (e.g., three or four different people) send such language imperfections a threshold number of times (e.g., ten or twenty times). In some examples, controller 110 may require a relatively higher number of detected language imperfection instances from other people prior to associating these instances to the user (e.g., as compared to the number of instances needed to associate a user's own misusage to the user). Or, put differently, controller 110 may identify a language imperfection as associated with a user in response to the user making the language imperfection a relatively low number of times (e.g., five times) and controller 110 may identify the language imperfection as associated with the user in response to a plurality of people (e.g., at least three people) sending the language imperfection to the user a relatively high number of times (e.g., at least fifteen times) without a negative response from the user (e.g., a derisive comment from the user).

In some examples, controller 110 may generate a profile of the user. Controller 110 may store the profile in database 120. The profile may include language imperfections associated with the user, and may further include a plurality of factors that indicate whether a user is likely to react positively or negatively to different versions of the language imperfection in different instances. For example, the profile may include a record of language imperfections that the user responds relatively well to in a first circumstance (e.g., a relatively low stress situation or encounter, such as a non-time sensitive issue that does not relate to expenditures) and responds relatively negatively to in a second circumstance (e.g., a relatively high stress situation or encounter, such as a time sensitive issue that does relate to expenditures).

To compile this profile, controller 110 may gather data from a plurality of locations. For example, controller 110 may identify posts online on a repository 150 that include certain language imperfections in response to which the user remarks or otherwise responds positively, such as with a positive comment or a positive emoji or the like. For another example, controller 110 may include posts online from a repository 150 (e.g., message board) that include certain language imperfections in response to which the user remarks or otherwise responds negatively, such as with a correction of the language imperfection or the like. In some examples, the profile may include a response (whether positive or negative) from the user to a language imperfection as used by chatbot 112 as described herein.

In addition to identified instances of the user responding positively or negatively, the profile as created and/or updated by controller 110 may include factors that may increase or decrease a likelihood that the user will respond positively to a language imperfection. These factors may include any factors that have a statistical likelihood to increase or decrease a positive response. For example, controller 110 may identify a profession of the user within repository 150, and therein update the profile to indicate that the user may, e.g., be relatively likely to have a negative reaction to language imperfections that relate to a field of that profession. For another example, controller 110 may identify an age, home city, or the like of a user, and therein update a profile as saved in database 120 to reflect that the user may be relatively likely to have negative reactions to language imperfections that relate to or are otherwise frequently used by people of that age, from that city, etc.

Controller 110 may gather such factors for a profile from a plurality of repositories 150. For example, controller 110 may identify a profession of the user from a professional social media network, and controller 110 may identify a home city of the user from a public database, and so on. Alternatively, or additionally, controller 110 may gather such data directly from the user using chatbot 112 (e.g., as a result of textual message asking about a zip code of the user). In some examples, controller 110 may further explicitly or surreptitiously conduct a personality assessment of the user prior to or during an interaction with chatbot 112 to identify further factors.

In certain examples, controller 110 may determine a severity of a language imperfection for one or more different circumstances. The severity may relate to a frequency with which controller 110 may cause chatbot 112 to include language imperfections in replies. For example, a profile may include an essentially limitless frequency, such that controller 110 may cause chatbot 112 to include a language imperfection for every reply of chatbot 112 that matches a language imperfection associated with the user (e.g., where controller 110 determines that the user effectively never uses a period for the last sentence of each question, controller 110 may cause chatbot 112 to include a language imperfection of avoiding a period for every reply sent by chatbot 112). For another example, a profile may include a frequency of once a minute, or once every three replies, or the like.

Alternatively, a severity may relate to a general extent of the language imperfection. For example, if the user is associated with a language imperfection of “mathematical errors,” controller 110 may set a severity of 5%, 10%, 20%, or the like, where the different percentages are the amount that the initial offered replies are incorrect. For another example, if the user is associated with a language imperfection of typographical errors (e.g., spelling errors of names or of words from certain roots or the words that are greater than a threshold length or the like), the severity may indicate the number of letters of the word that are incorrect (e.g., two letters that are switched, or one new letter, or one new letter and one missing letter, or the like).

Once controller 110 compiles a profile of a user and identifies one or more language imperfections associated with the user, controller 110 may cause chatbot to generate a response to the user that include one of these associated language imperfections. For example, controller 110 may analyze prompts as received by the user, where these prompts include questions to chatbot 112, statements that answer questions posited by chatbot 112, or the like. Controller 110 may further analyze whether responses from chatbot 112 to these prompts are related to any language imperfections associated with the user.

For example, controller 110 may receive a prompt from a user as sent to chatbot 112, in response to which controller 110 may gather information on the user over the chat with chatbot 112 and from repositories. Using this information, controller 110 may identify that the user regularly makes small math errors, and controller 110 may further identify that no factors in a profile of the user indicate that the user would have a negative reaction to math errors, in response to which controller 110 identifies that a language imperfection of “mathematical errors” is associated with the user. Following this, controller 110 may analyze prompts from the user to monitor for a prompt that relates to this language imperfection. For example, controller 110 may identify that a first prompt from the user of “how do I reset my password?” and a corresponding chatbot 112 reply of “click on this link” may not be related to the language imperfection of “mathematical errors” as neither the prompt nor the reply included any math.

However, controller 110 may identify that a follow-up prompt from the user of “how many days do I have until my current password expires?” and the chatbot 112 reply of “your password expires next Wednesday, eight days” is related to “mathematical errors” (e.g., as math is required to identify the number of days to be “eight”). As such, controller 110 may cause chatbot 112 to send a reply that includes, “your password expires next Wednesday, nine days,” followed by a subsequent message from chatbot 112 that says, “sorry, eight* days,” where the asterisk indicates an error. As a result of using a language imperfection, the user may be relatively less likely to identify that chatbot 112 is a chatbot, therein having increased enjoyment and confidence in interacting with chatbot 112. Further, given that controller 110 has identified that the user is associated with mathematical errors, controller 110 may have increased confidence that the user will not have a negative reaction to the proffered reply that includes the language imperfection.

Controller 110 may detect how the user responds to language imperfections as used by chatbot 112, identifying any positive or negative feedback from the user. Controller 110 may utilize machine learning techniques to update a record of language imperfections and profiles and the like within database 120 using this feedback from user devices 130. For example, controller 110 may identify a critical comment from the user (e.g., “can you please double check your math before you send it to me?”) and may therein update the profile of the user to include a negative association between mathematical errors and the user. Alternatively, controller may identify a positive comment from the user (e.g., “don't worry, I get those kinds of calculations wrong all the time!”) and may therein strengthen the association between the user and that selected language imperfection.

In some examples, controller 110 may similarly receive and/or detect positive and/or negative feedback from the user as relating to a severity of the language imperfection(s). For example, a user may comment positively or negatively regarding the severity, and/or a user may alter their own use of language imperfections in a way that controller 110 identifies as a negative reaction. For example, where a language imperfection of not using periods on a final sentence is associated with a user, and where controller 110 causes chatbot 112 to send replies without periods after final sentences, after which controller 110 detects the user start to use periods, controller 110 may detect this renewed usage of periods by the user as a negative reaction (e.g., as the user has started acting in a way that is divergent with chatbot 112 language imperfections). As a result of such a detected negative reaction, controller 110 may lower a severity of the language imperfection and/or stop using the language imperfection, dynamically reacting to the immediate feedback of the user.

Further, in some examples controller 110 may be configured to make chatbot 112 appear more human by showing empathy toward the user. For example, controller 110 may be configured to analyze prompts as provided to user devices 130 and/or data regarding users as gained by sensors 140 to determine an emotional state of the user. Controller 110 may analyze the prompt by using natural language processing (NLP) techniques as described herein to parse the words of the prompts and identify an emotional state. Further, controller 110 may analyze how the prompt was sent by the user, including if words were capitalized or italicized or bolded, identifying a tone of the user, a volume of the user, an intonation, a speed, whether or not the user is cutting off replies of chatbot 112, or the like. For example, where chatbot 112 and the user are communicating verbally, controller 110 may gather and analyze speech factors to identify an emotional state of the user. Additionally, or alternatively, controller 110 may utilize biometric sensors 140 such as a heart rate monitor or smart watch or the like to identify a body temperature or heart rate or the like of the user, and/or controller 110 may utilize video sensors 140 to identify gestures, blinking, pupil size, facial expression, clenched fists, or the like. Using such data, controller 110 may identify what a current state of a user is.

In such examples, controller 110 may create a baseline state for the user. Controller 110 may identify this baseline to include both the type of prompts that are sent by the user as well as the manner in which the user provides the prompts (e.g., the manner including such verbal and physical and semantic queues as described above). Controller 110 may use sensors 140 to determine when prompts as sent by the user deviate from this baseline. In response to this deviation, controller 110 may cause chatbot 112 to empathetically respond. Controller 110 may further identify the mood of the user, whether excited, frustrated, sad, or other moods, and respond in kind. For example, in response to detecting a frustrated user, controller 110 may cause chatbot 112 to reply “is there anything I can do?” Further, in response to detecting a sad user, controller 110 may cause chatbot 112 to reply, “I am truly sorry.” Further, in response to detecting an excited user, controller 110 may cause chatbot 112 to reply with a happy emoji or gif or with a sound effect or the like.

In some examples, controller 110 may further cause chatbot 112 to modulate a use of language imperfections based on how serious a topic of the prompts of the user is. For example, controller 110 may cause chatbot 112 to reduce a severity and/or general usage of language imperfections when prompts of a user become relatively more serious (e.g., stressful, important, or the like). For example, controller 110 may cause chatbot 112 to utilize more language imperfections with relatively greater severity when the user is asking about a less serious topic such as the weather, and controller 110 may cause chatbot 112 to utilize relatively less language imperfections with relatively less severity when the user provides a prompt about a relatively more serious topic such as a health or financial situation. As a result of this, controller 110 may identify that a user may have a positive reaction to mathematical language imperfections that relate to, e.g., how many calories are in a meal (a less serious topic), while that same user may have a negative reaction to mathematical language imperfections that relate to, e.g., how much money is in a savings account (a relatively more serious topic).

In some examples, controller 110 may have access to a predetermined set of topics that are all arranged on a scale of seriousness, and may modulate the usage of language imperfections based on where on this scale the prompt from the user and/or the reply as determined by chatbot 112 falls. Controller 110 may generate and/or update such a scale of seriousness based on the usage of language imperfections from the user. For example, controller 110 may be configured to assume that a user may make relatively less language imperfections on messages that the user considers serious, such that messages that contain less language imperfections controller 110 may consider relatively more serious and vice versa.

As described above, controller 110 may include computing device 200 with a processor configured to execute instructions stored on a memory to execute the techniques described herein. For example, FIG. 2 is a conceptual box diagram of such computing device 200 of controller 110. While controller 110 is depicted as a single entity (e.g., within a single housing) for the purposes of illustration, in other examples, controller 110 may include two or more discrete physical systems (e.g., within two or more discrete housings). Controller 110 may include interfaces 210, processor 220, and memory 230. Controller 110 may include any number or amount of interface(s) 210, processor(s) 220, and/or memory(s) 230.

Controller 110 may include components that enable controller 110 to communicate with (e.g., send data to and receive and utilize data transmitted by) devices that are external to controller 110. For example, controller 110 may include interface 210 that is configured to enable controller 110 and components within controller 110 (e.g., such as processor 220) to communicate with entities external to controller 110. Specifically, interface 210 may be configured to enable components of controller 110 to communicate with database 120, user devices 130, sensors 140, repositories 150, or the like. Interface 210 may include one or more network interface cards, such as Ethernet cards, and/or any other types of interface devices that can send and receive information. Any suitable number of interfaces may be used to perform the described functions according to particular needs.

As discussed herein, controller 110 may be configured to humanize a chatbot. Controller 110 may utilize processor 220 to humanize a chatbot. Processor 220 may include, for example, microprocessors, digital signal processors (DSPs), application specific integrated circuits (ASICs), field-programmable gate arrays (FPGAs), and/or equivalent discrete or integrated logic circuits. Two or more of processor 220 may be configured to work together to humanize a chatbot.

Processor 220 may humanize a chatbot according to instructions 240 stored on memory 230 of controller 110. Memory 230 may include a computer-readable storage medium or computer-readable storage device. In some examples, memory 230 may include one or more of a short-term memory or a long-term memory. Memory 230 may include, for example, random access memories (RAM), dynamic random-access memories (DRAM), static random-access memories (SRAM), magnetic hard discs, optical discs, floppy discs, flash memories, forms of electrically programmable memories (EPROM), electrically erasable and programmable memories (EEPROM), or the like. In some examples, processor 220 may humanize chatbots according to instructions 240 of one or more applications (e.g., software applications) stored in memory 230 of controller 110.

In addition to instructions 240, in some examples gathered or predetermined data or techniques or the like as used by processor 220 to humanize a chatbot may be stored within memory 230. For example, memory 230 may include information described above that may be stored in database 120, and/or may include substantially all of database 120. For example, as depicted in FIG. 2, memory 230 may include profile data 232, which includes language imperfection data 234.

As described above, language imperfection data 234 may include language imperfections that are associated with the user, whether typographical errors, grammatical errors, mathematical errors, or the like. Language imperfection data 234 may also include a correlation of the imperfection with a seriousness of a topic, such that some language imperfections are only associated with relatively less serious topics and other language imperfections are associated with topics of all or most levels of seriousness. For example, relatively “worse” language imperfections (e.g., major spelling errors) may be associated with topics that are relatively less serious, whereas relatively minor language imperfections (e.g., dropping a final period) may be associated with topics that are relatively more serious.

Memory 230 may further include profile data 232. Profile data 232 may include general demographic data of a user, such as demographic data that makes it statistically more or less likely for a user to approve or disapprove of a particular language imperfection as described herein. Profile data 232 may further include a severity associated with each language imperfection of language imperfection data 234, and/or a seriousness associated with each language imperfection of language imperfection data 234. Though only one profile data 232 section is depicted in FIG. 2 for purposes of illustration, in some examples controller 110 may store a plurality of profiles, one for each user for which controller 110 provides language imperfections for as described herein.

Memory 230 may include analysis techniques 236 that controller 110 may use to identify language imperfections, determine a positive and/or negative reaction to language imperfections from language of a user, track and identify gestures of a user, or the like. For example, analysis techniques 236 may include such data analyzing techniques as NLP techniques, image recognition techniques, speech-to-text techniques, or the like. NLP techniques can include, but are not limited to, semantic similarity, syntactic analysis, and ontological matching. For example, in some embodiments, processor 220 may be configured to parse comments from communication platforms and language arbiters or the like in repositories 150 to determine semantic features (e.g., word meanings, repeated words, keywords, etc.) and/or syntactic features (e.g., word structure, location of semantic features in headings, title, etc.) of posts and messages that are associated with the user and/or of language rules/definitions. Ontological matching could be used to map semantic and/or syntactic features to a particular concept. The concept can then be used to determine the subject matter. In this way, using NLP techniques, controller 110 may, e.g., identify a page of a social media platform as relating to a user, determine that language imperfections are being sent by and/or to the user, determine a positive (and/or neutral) response of the user to the language imperfections, and therein associate those language imperfections (and/or an associated severity and/or seriousness) with the user.

Similarly, analysis techniques 236 may include image recognition techniques such as pattern matching, shape identification, image recognition techniques, and/or object tracking techniques where images are received as a stream of images (e.g., as part of a video feed) to monitor a user as described herein. Controller 110 may use these analysis techniques 236 to analyze captured images of the user to determine an emotional state of the user to enable controller 110 to empathetically response to that state as described herein.

Controller 110 may further include chatbot instructions 238. Chatbot instructions 238 may be executed by processor 220 to cause chatbot 112 to chat with a user as described herein. Chatbot instructions 238 may cause chatbot 112 to write messages to a user in response to written messages from the user, verbally talk with a user, or the like.

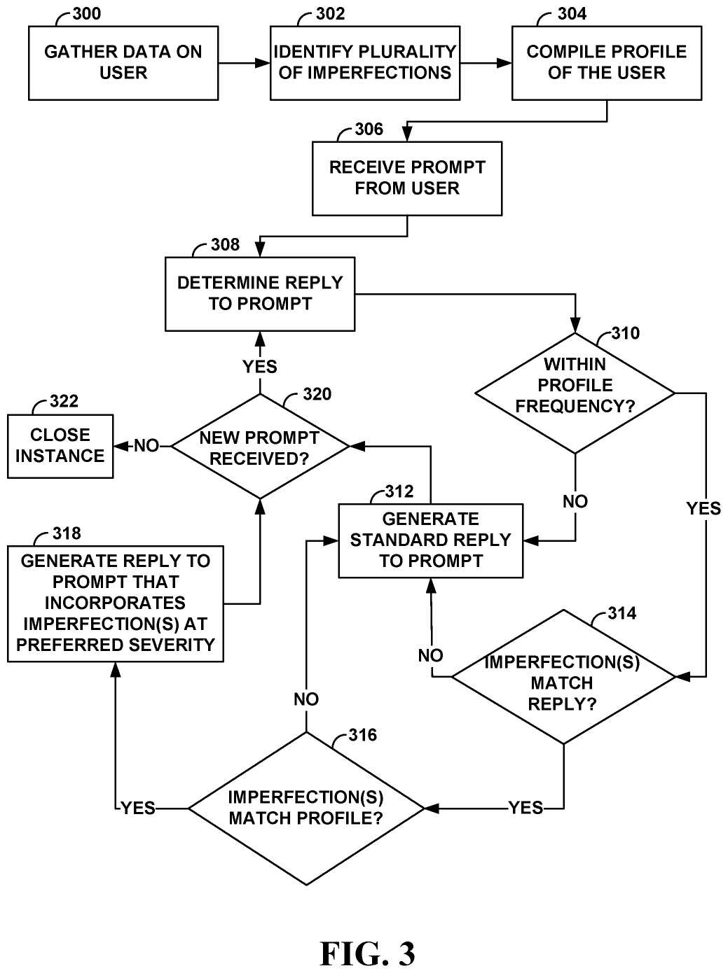

Controller 110 may make a chatbot appear more human according to many techniques. For example, controller 110 may make a chatbot appear more human according to the flowchart depicted in FIG. 3. The flowchart of FIG. 3 is discussed with relation to FIG. 1 for purposes of illustration, though it is to be understood that other systems may be used to execute the flowchart of FIG. 3 in other examples. Further, in some examples system 100 may execute a different method than the flowchart of FIG. 3, or system 100 may execute a similar method with more or fewer steps in a different order, or the like.

Controller 110 may gather data on the user (300). Controller 110 may gather this data from various repositories 150, such as social media platforms or communication platforms or public registries or the like. Controller 110 may further gather this data from one or more sensors 140 associated with the user. Additionally, controller 110 may gather data directly from the user as the user sends the data to chatbot 112 via a virtual interface on user device 130. This data may include communication sent to and by the user. Further, this data may include demographic data on the user.

Controller 110 may identify a plurality of language imperfections associated with the user (302). The language imperfections may be associated with the user as a result of the user making the language imperfections, the language imperfections being made by others when communicating with the user, or the like. Controller 110 may identify these language imperfections from the gathered data. Controller 110 may further compile a profile of the user from the data (304). The profile may include the plurality of language imperfections, as well as an associated severity and/or seriousness associated with some or all of the language imperfections. The profile may indicate which of the language imperfections the user is most likely to respond positively or negatively with, based on various factors. These factors include historical responses of the user, demographic traits of the user that have a statistical correlation to language imperfection response (e.g., where doctors may be relatively less likely to respond positively to misspelled pharmaceuticals or medical procedures, and engineers may be relatively less likely to respond positively to calculation errors, and journalists may be relatively less likely to respond positively to grammatical errors, and the like), or the like.

Controller 110 may detect a received prompt from a user (306). This prompt may be directed to chatbot 112. The prompt may be an inquiry or statement or the like that is intended to get a response from chatbot 112. Chatbot 112 may determine a response to the prompt (308). Chatbot 112 may determine a response using a question-and-answer algorithm. The prompt as initially determined by chatbot 112 may include substantially no language imperfections.

Controller 110 may determine whether or not the inclusion of one or more language imperfections would be within a frequency as set by a profile of the user (310). For example, controller 110 may determine that a profile of the user dictates that language imperfections should be used on average once every three replies, and/or once every 90 seconds, or the like. In some examples the frequency may be static across all situations. In other examples, a frequency may change depending upon a seriousness of a detected topic or seriousness of the prompt.

If a usage of a language imperfection would not be within a frequency of the profile, controller 110 causes chatbot 112 to generate a standard (e.g., without a language imperfection) reply to the prompt without a language imperfection (312). For example, if a frequency dictates to use a language imperfection once every three replies and the previous reply included a language imperfection, controller 110 may determine that the usage of a language imperfection would not be more frequent than the allotted frequency threshold. Alternatively, if a language imperfection has not been used or is otherwise within the frequency threshold set by the profile, controller 110 may determine if any language imperfections match the reply (314).

For example, controller 110 may use NLP techniques to compare the reply generated by chatbot 112 with all of the language imperfections identified by controller 110 to determine if any could be used within the reply. Controller 110 may determine both which language imperfections match the reply as well as what severity of the matched language imperfections are associated with the reply. If none of the language imperfections match the reply, controller 110 causes chatbot 112 to generate the standard reply without any language imperfections as depicted in FIG. 3 (312).

If any language imperfections match the reply, controller 110 may determine if a usage of the language imperfections in this situation match the profile of the user (316). For example, controller 110 may determine if a seriousness of the topic of the prompt matches the usage of the identified language imperfection. For another example, controller 110 may determine that new gathered data (e.g., such as a previous negative response) indicates that the user may have a negative response to the language imperfection.

In some examples, the user profile may indicate that a single consistent language imperfection such a word that is always misspelled the wrong way is associated with a negative response, whereas varied language imperfections such as a random and different misspelling every few replies may be associated with a positive response. As such, controller 110 may be configured to dynamically change the usage of language imperfection for such users over time. For example, controller 110 may identify that a user has a negative reaction to a single word that is always spelled incorrectly (e.g., as the user interprets this as a sign of a less informed conversationalist), though controller 110 identifies that the same user has a positive or neutral reaction to messages with an occasional random word that contain a typographical error (e.g., such as a sentence that includes “teh” rather than “the” following multiple correct spellings of “the”) every other minute (e.g., as the user interprets these messages as coming from a hard-working conversationalist trying to type quickly, particularly if the conversationalist/chatbot promptly “corrects” the typographical error in a subsequent message). In this way, controller 110 may dynamically change language imperfections over time to better humanize chatbot 112. If controller 110 determines that the language imperfection(s) identified as matching the reply would not match the profile, controller 110 may cause chatbot to generate the standard reply without the language imperfections (312).

Controller 110 may store (e.g., within database 120) a record of the language imperfections being used, as well as store any positive or negative responses of the user to the language imperfections. If a response from a user is positive, controller 110 may strengthen a correlation of the user and the language imperfections, such that the language imperfections are more likely to be used in the future. If a response from the user is negative, controller 110 may weaken a correlation between the user and the language imperfections, such that the language imperfections are relatively less likely to be used in the future (e.g., not used as frequently, or not used in the current topic, or not used at all). Otherwise, if the language imperfections match the profile, controller 110 may cause chatbot 112 to generate a reply to the prompt that includes the language imperfection at the preferred severity (318). Chatbot 112 may generate the reply with the language imperfection in the same virtual interface (e.g., a chatting window or video conference window or the like) over which the user provided the prompt.

Whether or not a reply is sent with any language imperfections, after the prompt is sent controller 110 and/or chatbot 112 may monitor for additional prompts as sent by the user (320). If additional prompts are sent by the user, controller 110 may cause chatbot 112 to determine a reply to the prompt, such that the language imperfection cycle (e.g., 308-320) may repeat pseudo-indefinitely. Otherwise, if a new prompt is not received, controller 110 may close the instance of chatbot 112 (322).

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
receiving, from a user over a virtual interface, a message that includes a prompt;
identifying a language imperfection associated with the user; and
generating a reply to the prompt over the virtual interface that includes the language imperfection.

2. The computer-implemented method of claim 1, wherein identifying the language imperfection includes analyzing one or more messages received from the user over the virtual interface, the one or more messages including a prior utilization of the language imperfection by the user.

3. The computer-implemented method of claim 1, wherein identifying the language imperfection includes analyzing one or more messages sent by the user over one or more social media platforms, the one or more messages including a prior utilization of the language imperfection by the user.

4. The computer-implemented method of claim 1, wherein identifying the language imperfection includes:
identifying one or more messages sent to the user over one or more social media platforms, the one or more messages including a prior utilization of the language imperfection; and
identifying that the user did not have a negative reaction to receiving the one or more messages.

5. The computer-implemented method of claim 1, wherein the generated reply includes the language imperfection in response to determining that the language imperfection matches a seriousness of the prompt.

6. The computer-implemented method of claim 1, wherein the reply is a first reply, further comprising generating a second reply to the prompt that corrects the language imperfection.

7. The computer-implemented method of claim 1, wherein the language imperfection includes at least one of a typographical error, a grammatical error, and a mathematical error.

8. The computer-implemented method of claim 1, wherein the message is a first message and the prompt is a first prompt and the reply is a first reply, further comprising:
receiving, from the user, a second message that includes a negative response to the language imperfection;
modifying the association of the language imperfection and the user;
receiving, from the user, a third message that includes a second prompt that is similar to the first prompt; and
generating a second reply to the second prompt that does not include the language imperfection.

9. The computer-implemented method of claim 1, further comprising identifying a severity of the language imperfection, wherein the generated reply includes the language imperfection at the identified severity.

10. The computer-implemented method of claim 1, wherein the language imperfection is a first language imperfection, the method further comprising:
compiling a profile of the user that includes at least one preference associated with the user;
identifying the first language imperfection and a second language imperfection; and
identifying, using the profile, that the at least one preference opposes the second language imperfection, wherein generating the reply includes the first language imperfection and does not include the second language imperfection in response to identifying that the at least one preference opposes the second language imperfection.

11. A system comprising:
a processor; and
a memory in communication with the processor, the memory containing instructions that, when executed by the processor, cause the processor to:
receive, from a user over a virtual interface, a message that includes a prompt;
identify a language imperfection associated with the user; and
generate a reply to the prompt over the virtual interface that includes the language imperfection.

12. The system of claim 11, wherein the language imperfection includes at least one of a typographical error, a grammatical error, or a mathematical error.

13. The system of claim 11, the memory further containing instructions that, when executed by the processor, cause the processor to identify a severity of the language imperfection, wherein the generated reply includes the language imperfection at the identified severity.

14. The system of claim 11, wherein the message is a first message and the prompt is a first prompt and the reply is a first reply, the memory further containing instructions that, when executed by the processor, cause the processor to:
receive, from the user, a second message that includes a negative response to the language imperfection;
modify the association of the language imperfection and the user;
receive, from the user, a third message that includes a second prompt that is similar to the first prompt; and
generate a second reply to the second prompt that does not include the language imperfection.

15. The system of claim 11, wherein the language imperfection is a first language imperfection, the memory further containing instructions that, when executed by the processor, cause the processor to:
compile a profile of the user that includes at least one preference associated with the user;
identify the first language imperfection and a second language imperfection; and
identify, using the profile, that the at least one preference opposes the second language imperfection, wherein generating the reply includes the first language imperfection and does not include the second language imperfection in response to identifying that the at least one preference opposes the second language imperfection.

16. A computer program product, the computer program product comprising a computer readable storage medium having program instructions embodied therewith, the program instructions executable by a computer to cause the computer to:
receive, from a user over a virtual interface, a message that includes a prompt;
identify a language imperfection associated with the user; and
generate a reply to the prompt over the virtual interface that includes the language imperfection.

17. The computer program product of claim 16, wherein the message is a first message and the prompt is a first prompt and the reply is a first reply, the computer readable storage medium having additional instructions embodied therewith that, when exceed by the computer, cause the computer to:
receive, from the user over a virtual interface, a second message that includes a negative response to the language imperfection;
modify the association of the language imperfection and the user;
receive, from the user, a third message that includes a second prompt that is similar to the first prompt; and
generate a second reply over the virtual interface to the second prompt that does not include the language imperfection.

18. The computer program product of claim 16, the computer readable storage medium having additional instructions embodied therewith that, when exceed by the computer, cause the computer to identify a severity of the language imperfection, wherein the generated reply includes the language imperfection at the severity.

19. The computer program product of claim 16, wherein the language imperfection includes at least one of a typographical error, a grammatical error, or a mathematical error.

20. The computer program product of claim 16, wherein the language imperfection is a first language imperfection, the computer readable storage medium having additional instructions embodied therewith that, when exceed by the computer, cause the computer to:
compile a profile of the user that includes at least one preference associated with the user;
identify the first language imperfection and a second language imperfection; and
identify, using the profile, that the at least one preference opposes the second language imperfection, wherein generating the reply includes the first language imperfection and does not include the second language imperfection in response to identifying that the at least one preference opposes the second language imperfection.
